(19) United States
(12) Patent Application Publication
(10) Pub. No.: US 2004/0064828 A1
(43) Pub. Date: Apr. 1, 2004

(54) Supplanting first device objects with second device objects

(76) Inventor: David Payton Cox, Santa Barbara, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/260,438

(22) Filed: Oct. 1, 2002

(51) Int. Cl. G06F 9/00

(52) U.S. Cl. 719/327

(57) ABSTRACT

A filter driver (usable with a system having a bus, a host connected to the bus and one or more devices connected to the bus) that supplants first device objects (DOs) with second DOs. Such a filter driver includes: an intercept code portion to intercept a set of data identifying one or more first DOs, respectively; a determination code portion to determine addresses of second DOs corresponding to the first DOs identified by the data set, respectively; and a change code portion to change the data set such that members thereof identify the second DOs rather than the first DOs.

### BACKGROUND OF THE INVENTION

The WINDOWS driver model (WDM) is a driver technology developed by the MICROSOFT Corporation that supports drivers which are compatible for WINDOWS 98, 2000, ME AND XP. WDM allots some of the work of the device driver to portions of the code that are integrated into the operating system. These portions of code handle all of the low-level buffer management, including direct memory access (DMA) and plug-n-play (PnP) device enumeration.

A DRIVER_OBJECT data structure, corresponding to a single loaded device driver according to WDM, contains a table of function pointers referred to as the dispatch table. The numerical values used to index into the table, namely to find specific functions, are called function codes and are given symbolic names that refer to a type of input/output (I/O) such as READ or WRITE or refer to other requests such as CREATE, DEVICE_CONTROL and PnP.

The function located in the table at the corresponding index is expected to implement logic for carrying out such an I/O request. The operating system delivers I/O request packets (IRPs) to these functions. The operating system also, for each IRP, identifies the device for which the request is intended, in the form of a DEVICE_OBJECT data structure. Such a DEVICE_OBJECT was previously initialized by the driver and represents a single device handled (driven) by the driver. A driver defines its own dispatch functions and inserts them into the dispatch table in its DRIVER_OBJECT at the time the driver initializes itself. A device node (devnode) is the context (set of data structures and configuration storage) representing a single device within a WDM operating system. If the device is active (connected and enabled for use), then (in the kernel) such a context will include a stack of device object structures, typically one per driver in the layered driver architecture for that type of device.

Device objects (DOs) in the stack fall into three categories. The bottom-most device object is created by the driver for the bus that provides access to the device and is called the physical device object (PDO). The bus driver provides raw communications capability to the device, but little in the way of higher-level device-specific functionality. Typically a function device object (FDO) is created by a driver which provides access to device-specific and higher-level capabilities of the device. An FDO will be located higher in the device stack than a PDO. In addition to the PDO and FDO, there may optionally be one or more filter device objects (FiDOs). FiDOs may be located in the device stack between the PDO and FDO, or above the FDO.

FIG. 1 is a software block diagram that illustrates the layered relationships of objects according to the WDM architecture. Such a WDM architecture 100 includes device 102 and a bus 104 to which the device 102 is physically connected. A host computing device 105 is also connected to the bus 104. The host 105 has a variety of software loaded on it including an application 106, an application 136, a PnP manager 108, a bus DO enumerator 110, a bus function driver 112, an optional device lower filter driver 114, a device function driver 116 and an optional device upper filter driver 118.

In a storage area network (SAN), a device (not depicted) can be sub-divided into smaller units representing different functions, known as logical units (LUNs). Device 102 may be such a LUN. A device or LUN can represent a type of massive non-volatile storage, configuration functionality, monitoring functionality and/or mechanical functionality (such as tape changing), etc. The host 105 can have an application 106 that stores data to, reads data from and/or otherwise utilizes the functionality of device 102, i.e., consumes the services of the device 102. In some SANs, there can be multiple non-volatile memory devices or other devices 102, some of which the host 105 might not have permission to access.

When a device 102 is connected to a bus 104, the bus driver 112 notifies the operating system of a change on the bus by calling the kernel function IoInvalidateDeviceRelations( ). The operating system, i.e., the PnP manager 108, issues a request to the bus driver 112 via an IRP sent downward in the layered architecture instructing the bus driver 112 to return objects for all of the devices currently connected to the bus 104. In response to this query, the bus driver 112 creates PDOs for any devices newly connected to the bus, and then returns a set of pointers to (addresses of) all PDOs representing devices connected to the bus, including those previously albeit currently connected. Strictly speaking, the set of DOs whose addresses are returned are not PDOs until the operating system, namely the PnP manager, examines such a set and first becomes aware of the devices within the set.

The PnP manager 108 locates and loads into volatile memory (if not already loaded) (not depicted in FIG. 1) of the host 105 the function drivers and filter drivers for the newly-connected devices and gives each filter driver and/or function driver an opportunity to create and attach corresponding FiDOs or FDOs to the stack/node 128 rooted in the new PDO.

In FIG. 1, a stack 134 for the bus 104 is depicted. The stack 134 includes a PDO for the bus 130 (generated by the bus DO enumerator 110) and a bus FDO 132 (generated by the bus function driver 112).

A stack 128 for the device 102 has also been created. The stack 128 includes a PDO 120 (generated by the bus function driver 112), and (possibly) a FiDO 122 (generated by the optional device lower filter driver 114, if present), an FDO 124 (generated by the device function driver 116) and (possibly) an FiDO 126 (generated by the device upper filter driver 118, if present). In other words, if the device lower filter driver 114 and/or the device upper filter driver 118 are not present, then the FiDO 122 and/or the FiDO 126 will not be present, respectively.

Assembly of a stack 128 representing a device 102 is depicted in more detail via Background Art FIG. 4, which is a software block diagram. At action 402, the device 102 is connected to the bus 104. At action 404, the bus 104 notifies the bus function driver 112 of a change in the devices connected to it. At action 406, the bus driver 112 notifies the PnP manager 108 that a change in devices connected to the bus 104 has occurred. At action 408, the PnP manager 108 issues a query to learn which devices are connected to the bus 104.

At action 410, the bus driver 112 creates a device object (DO) (assumed to have address, A) representing the device 102. This corresponds to Stage 1 in FIG. 4. Subsequent stages of the assembly of stack 128 are depicted successively to the right of Stage 1.

At action 412, the bus driver 112 creates a list or set 413 of pointers to the DOs representing devices connected to the bus 104. For simplicity, the address, A, of the DO 120 is listed explicitly in the set 413. At action 414, the bus driver 112 sends the set 413 to the PnP manager 108. At Stage 2, the PnP manager 108 recognizes or sees the DOs corresponding to the pointers 413, making them into physical DOs (PDOs). At this point a devnode is associated with the stack 128.

Next, the PnP manager 108 participates in the creation of a stack for each new DO identified by the set 413. Again, for simplicity, FIG. 4 assumes that the only new DO in the set 413 is DO 120.

At action 416, the PnP manager 108 passes the PDO 120 to the lower filter driver 114. At action 418, the lower filter 114 driver creates and attaches the filter DO (FiDO) 122 to the stack 128, i.e., the PDO 120 (which is located immediately below the FiDO 122) is manipulated so as to indicate that the FiDO 122 is attached to it. At action 420, the PnP manager 108 passes the PDO 120 to the function driver 116. At action 422, the function driver 116 creates and attaches the function DO (FDO) 124 to the stack 128, i.e., manipulates the FiDO 122 to indicate the FDO 124 is attached to it. At action 424, the PnP manager 108 passes the PDO 120 to the upper filter driver 118. At action 426, the upper filter driver 118 creates and attaches the filter DO (FiDO) 126 to the stack 128.

At action 428, the PnP manager notifies potential consumers of the device's services of the arrival of the device. Such potential consumers include dependent device drivers 430 and application 106.

Yet more detail as to stack assembly according to the Background Art is provided in FIG. 5, which is a sequence diagram according to the unified modeling language (UML) principles. The sequence 500 in FIG. 5 depicts the various interactions between the device 102, the bus 104, the bus driver 112, the PnP manager 108, the device lower filter driver 114, the device function driver 116, the device upper filter driver 118 and the application 106. The device 102 connects to the bus 104 at action 518. The bus 104 then notifies the bus driver 112 of a change in connected devices at action 520. The bus driver 112 notifies the PnP manager 108 of a change in connected devices at action 522. The PnP manager 108 queries the bus driver 112 to obtain a set of connected devices via action 524, e.g., an IRP, to the bus driver 112. If not already known by the bus driver 112, then the bus driver 112 queries the bus 104 to discover the connected devices via the query at action 526. The bus driver 112 creates PDOs for newly discovered devices and returns a set 413 of pointers to (addresses of) all PDOs representing devices connected to the bus to the PnP manager at action 528.

Upon receiving the set of PDOs, the PnP manager enters a loop 530 by which it handles any PDO in the set of which the PnP manager was not previously aware (see legend 529).

At action 531, the PnP manager 108 designates the current new DO as a PDO and creates a devnode associated with the DO. At action 532, the PnP manager passes one of the PDOs to any device lower filter drivers 114 that might be present. In response, the device lower filter driver attaches a new FiDO to the corresponding stack 128 (see legend 534 in FIG. 5). Then the PnP manager 108 passes the PDO to the device function driver 116, at action 536.

In response, the device function driver 116 attaches a new, named FDO to the device stack 128 and correspondingly registers device-class interfaces (see legend 538) by which consumers can access the device stack. Next, the PnP manager 108 passes the PDO to any device upper filter drivers 118, at action 540. In response, the device upper filter drivers 118 attach a new FiDO 126 to the device stack 128 (see legend 542). Lastly, the PnP manager 108 notifies applications 106 of the availability of the new device 102, at action 544. As a result, the applications 106 may utilize (consume the services of) the device 102 (see legend 546). At legend 548, the loop 530 is repeated for each DO identified by the set.

In a situation in which the host 105 has multiple host bus adapters (not depicted in FIG. 1) and device 102 has multiple ports (not depicted in FIG. 1), then multiple paths can exist between the host 105 and the device 102. Within the host, each path is given its own path identification (ID). Each path is perceived as a distinct device and so has a corresponding stack 128, which includes the distinct path ID. Each stack is part of a data structure in a device tree referred to as a device node (devnode). As such, a host can have multiple devnodes, namely multiple stacks, for the same device.

Subsequently, when a device, e.g., 102, is to be disconnected or disabled, the one or several stacks must be disassembled. From the top down, under the coordination of the PnP manager 108, each driver detaches its device object from the stack and deletes it. At the bottom, however, the bus function driver 112 generally will not delete the corresponding PDO unless it has actually detected that the corresponding device is no longer connected to the bus.

### SUMMARY OF THE INVENTION

An embodiment of the invention provides a filter driver (usable with a system having a bus, a host connected to the bus and one or more devices connected to the bus) that supplants first device objects (DOs) with second DOs. Such a filter driver includes: an intercept code portion to intercept a set of data identifying one or more first DOs, respectively; a determination code portion to determine addresses of second DOs corresponding to the first DOs identified by the data set, respectively; and a change code portion to change the data set such that members thereof identify the second DOs rather than the first DOs.

Additional features and advantages of the invention will be more fully apparent from the following detailed description of example embodiments, the appended claims and the accompanying drawings.

### BRIEF DESCRIPTION OF THE DRAWINGS

FIG. 1 is a software block diagram according to the Background Art

FIG. 2 is a hardware block diagram according to the an embodiment of the invention.

FIG. 3 is a hardware block diagram according to an embodiment of the invention.

FIG. 4 is a software block diagram according to the Background Art

FIG. 5 is a sequence diagram according to the Background Art.

FIG. 6 is a software block diagram according to an embodiment of the invention.

FIG. 7 is a sequence diagram according to an embodiment of the invention.

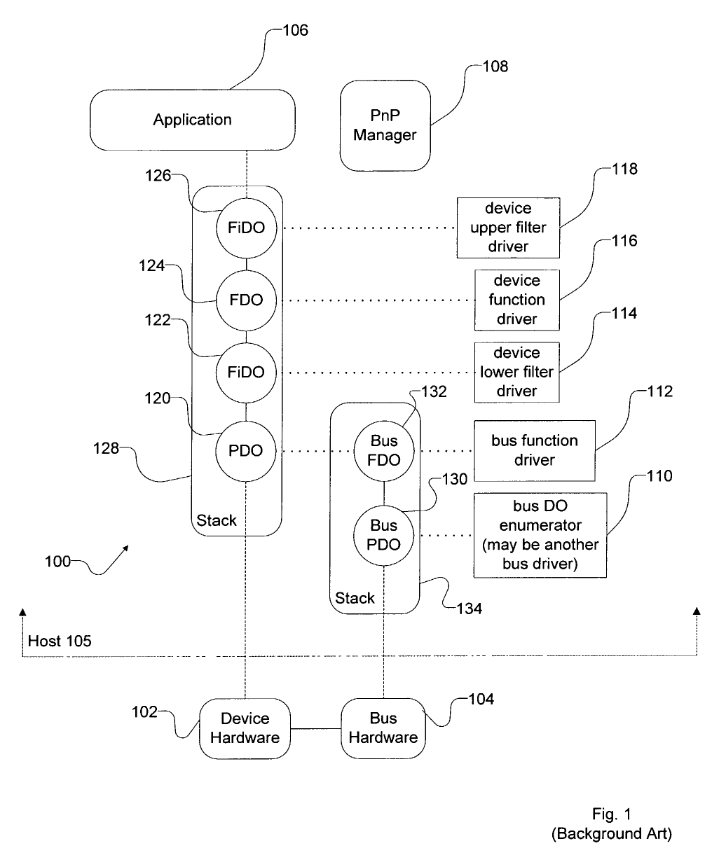

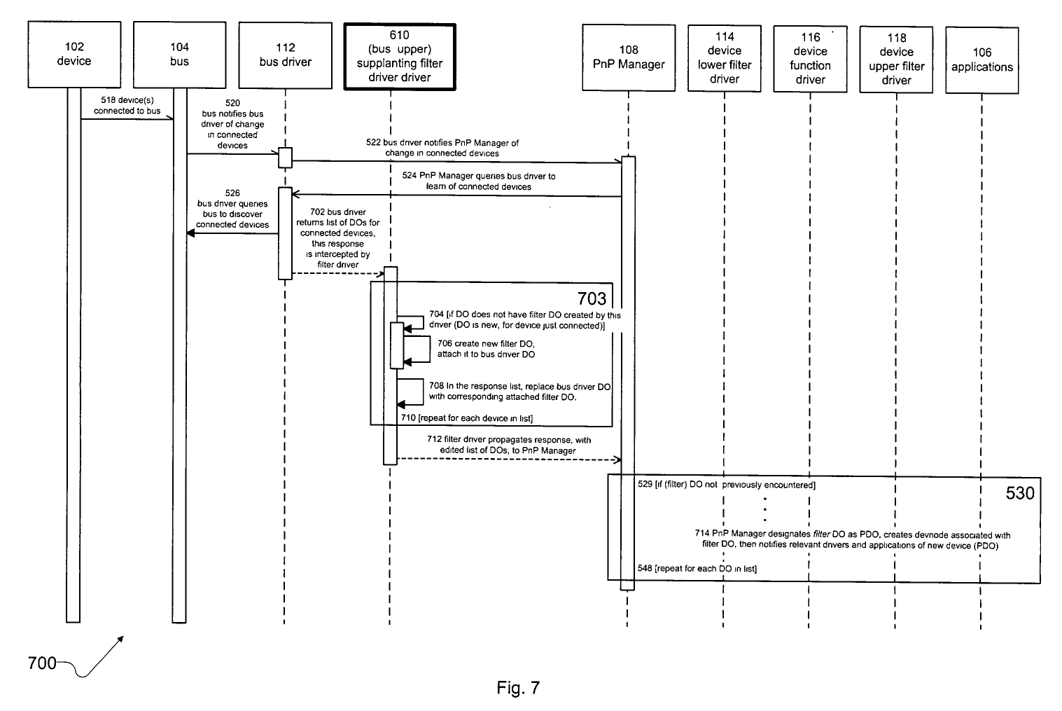

FIGS. 5 and 7 are UML sequence drawings. Actions are depicted with arrows of different styles. A [symbol] indicates an action that expects a response action. A [symbol] indicates a response action. A [symbol] indicates an action for which the response is implied. And a [symbol] indicates an action for which no response is expected.

### DETAILED DESCRIPTION OF THE PREFERRED EMBODIMENTS

Embodiments of the invention provide software that facilitates disassembling a device stack and then being able to rebuild the stack without having to physically disconnect and reconnect the device, and alternatively also without having to reboot the host. Such software can be part of a greater system that coordinates access privileges of several hosts to network devices. Such a system can be other software loaded on a host, e.g., that itself might not be able to access the devices.

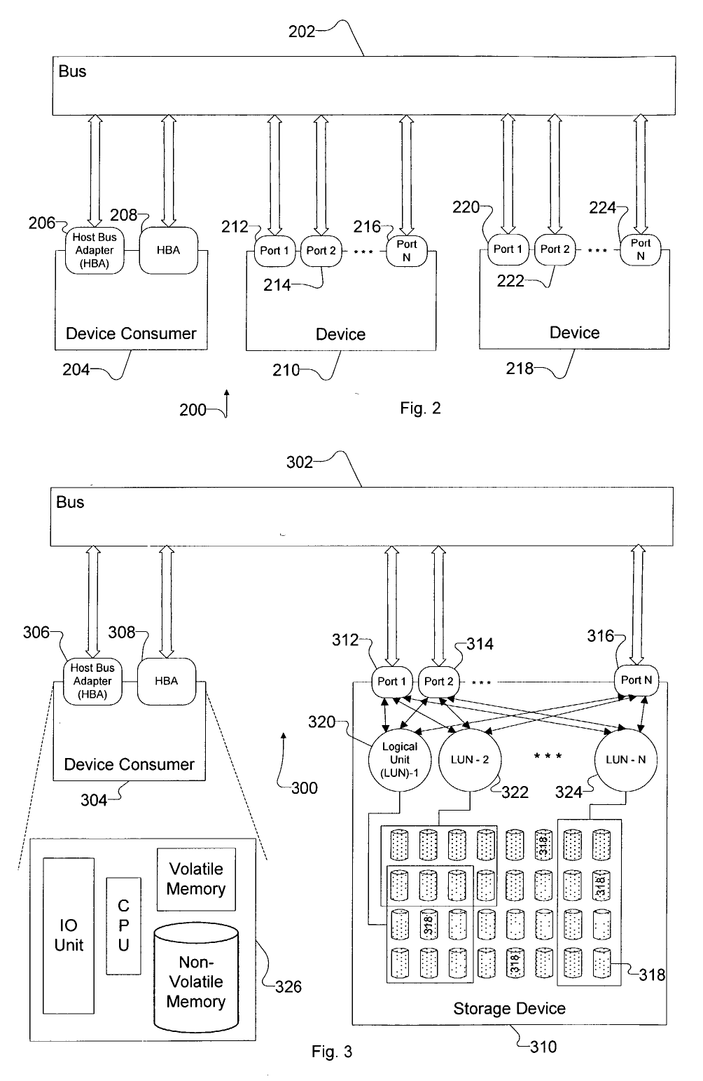

FIG. 2 depicts a hardware block diagram of a system 200 according to an embodiment of the invention. The system 200 includes a bus (e.g., SCSI, Ethernet (iSCSI/IP/Gbit Ethernet), fibre channel, etc.) 202 to which are connected a consumer of device services (hereafter a device consumer) 204, a device 210 and a device 218.

The device consumer 204 includes host bus adapters (HBAs) 206 and 208 that permit the device consumer 204 to connect to and interact with the bus 202. The device 210 has port 1 (212), port 2 (214), . . . port N (216). Device 218 has port 1 (220), port 2 (222), . . . port N (224). It is noted that reuse of the variable N does not imply that the different devices must have the same number of ports. For simplicity of disclosure, only two devices 210 and 218 and two HBA's 206 and 208 have been depicted, but fewer or more devices and fewer or more HBAs could be attached to the bus depending upon the particular circumstances of a situation.

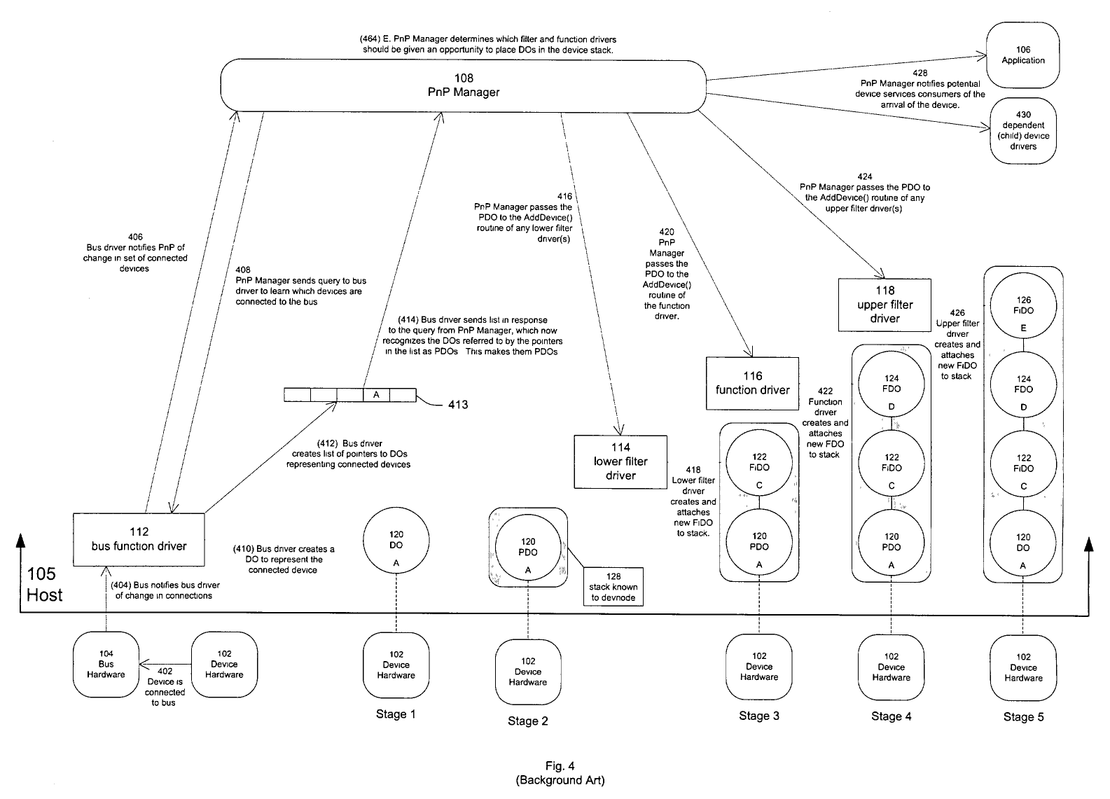

FIG. 3 depicts a hardware block diagram corresponding to a particular type of system 200, namely a storage area system or storage area network (SAN) 300. The SAN 300 includes a bus 302, a host in the role of device consumer 304 and a non-volatile storage device 310. The device consumer 304 can include HBAs 306 and 308. Fewer or greater numbers of HBAs 306/308 can be provided depending upon the circumstances of a situation. So, in general, the device consumer (host) 304 can be considered to have a number of HBAs represented by the integer variable M.

The device consumer 304 can take the form of a computer 326 including at least a CPU, input device(s), output device(s) and memory. For example, the computer 326 has been depicted as including a CPU, an 10 device, volatile memory such as RAM and non-volatile memory such as ROM, flash memory, disc drives and/or tape drives.

The storage device 310 includes port 1 (312), port 2 (314), . . . port N (316) and logical units (LUNs) 1, 2, . . . N. Also included in the storage device 310 are non-volatile memories 318 such as disc drives, tape drives and/or flash memory. To remind the reader of the logical nature of a LUN, a simplistic mapping between the LUNs 320, 322 and 324 and to physical memory devices 318 has been illustrated in FIG. 3. For the purposes of this discussion, a LUN will be considered interchangeable with a device 210 or 218.

Each logical unit LUN-i can be accessed through the N ports of the storage device 310. An application running on the host (device consumer) 304 can get out to the bus 302 via each of the M host bus adapters (HBAs) 308. Hence, there can be M×N paths from the host 304 to the logical device LUN-i. Again, each path can be presented as a device stack. And each stack can be associated with a devnode data structure within a device tree according to WDM architecture.

In the environment of a storage area network 300, a storage manager application operates to prevent consumer applications running on device consumers 304 from accessing LUNs to which the host (or device consumer) 304 has not been granted access by the storage manager. Such a storage manager application can be loaded onto and executed by, e.g., a computer 326 that can communicate with the host 304 via the bus 302 or a different connection (not depicted).

There can be instances in which a user of the storage manager wishes to delete access permission of a host to a LUN. As briefly mentioned in the Background section, this necessitates disassembling the corresponding stack, e.g., 128, by removing each of the device objects (DOs) 126, 124, 122 and 120. Removal of the PDO 120 at the root of this stack 128 requires physical disconnection of the device 102. When that occurs and the PDO 120 is subsequently removed, the corresponding data structure in the device tree, namely the device node (devnode) has its state changed to indicate that the device 102 is no longer attached to the bus.

But if the device 102 is not physically removed, then the PDO 120 cannot be removed. And if the PDO 120 is not removed, then the state of the devnode is left unchanged such that the devnode continues to indicate that the device 102 exists or is in a state of limbo awaiting physical disconnection. An embodiment of the invention is a recognition that, should the user of the storage manager subsequently grant access permission again to the host, e.g., 105, the corresponding stack 128 for the device 102 cannot be rebuilt because the associated devnode according to the Background Art cannot be changed from a state in which the device 102 is considered to be awaiting imminent disconnection. In other words, the devnode gets stuck in a dead end state.

An embodiment of the invention solves this problem via the recognition of two circumstances: (1) that deletion of the PDO changes a state of the associated devnode so that the stack 128 of the device 102 can be rebuilt later if need be; and (2) it is not necessary for a PDO to be the DO created by the bus driver, i.e., the DO closest to the device.

Further according to the recognition embodiments of the invention, it has been recognized that a PDO is a DO that has a pointer to the associated devnode. It is the plug-and-play (PnP) manager, e.g., 108, that manipulates a device object to include a pointer to the devnode, thereby establishing the DO as a physical DO (PDO). The DOs that are manipulated in this manner by the PnP manager 108 are identified by the set of pointers enumerated by the bus driver 112 in reply to a connected devices query by the PnP manager 108.

Hence, an embodiment of the invention is a recognition that a FiDO can be substituted (via a bus upper filter driver) for the DO generated by the bus driver 112 in the set of pointers being enumerated to the PnP manager 108, which causes the PnP manager 108 to treat the substituted DO (FiDO) effectively as the PDO. In other words, the DO generated by the bus driver 112 can be supplanted as the PDO via the operation of a bus upper filter driver, creating an effective PDO (known as a FiDO/PDO). A FiDO/PDO can be deleted without disturbing the DO created by the bus, i.e. the bus DO. As such, the stack can be disassembled and then later reassembled without the need for an intervening reboot and/or physical disconnection and reconnection of the device.

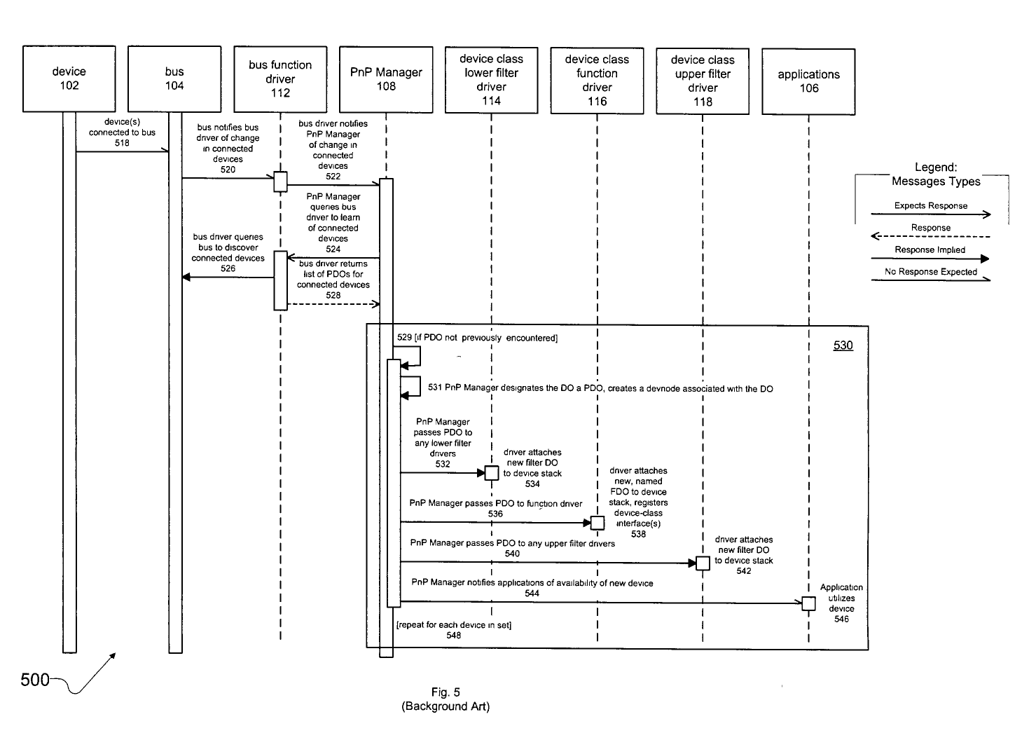

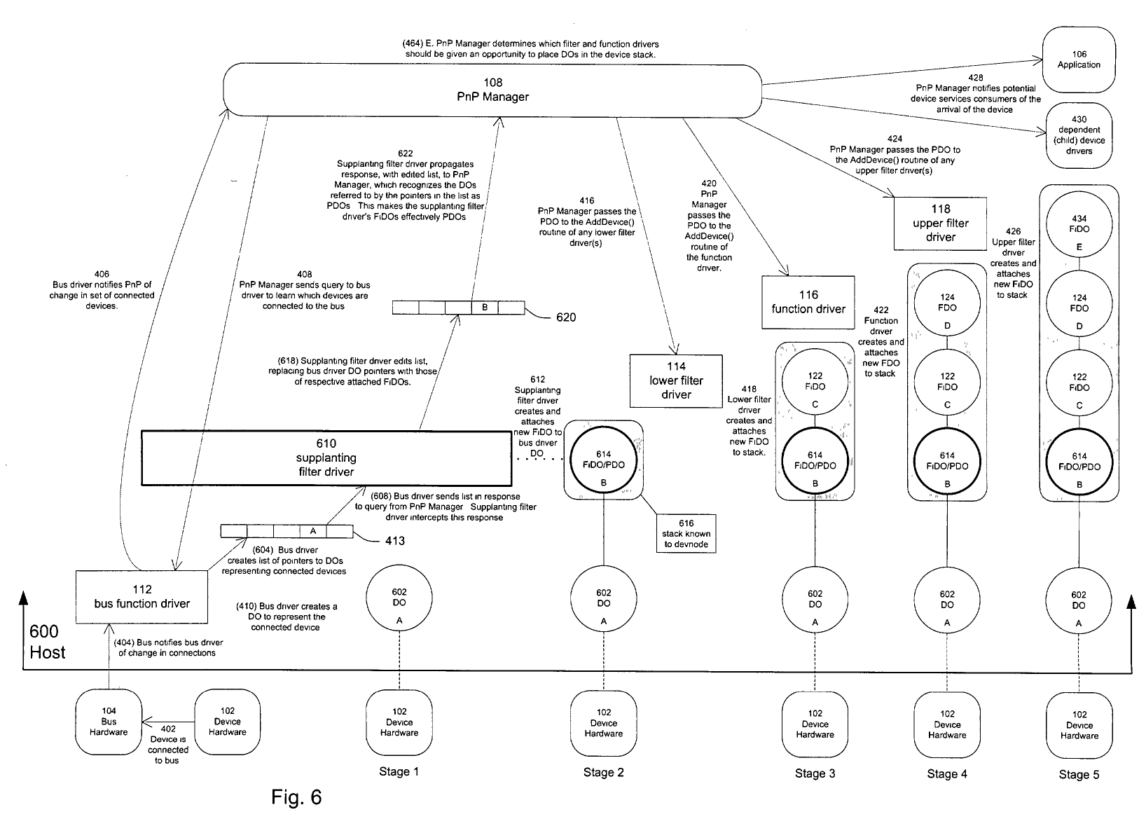

Assembly of a stack according to an embodiment of the invention is depicted in more detail via FIG. 6, which is a software block diagram. Similarities to Background Art FIG. 4 have been denoted by reuse of reference numbers for corresponding actions.

At action 402 in FIG. 6, the device 102 is connected to the bus 104. At action 404, the bus 104 notifies the bus function driver 112 of a change in the devices connected to it. At action 406, the bus driver 112 notifies the PnP manager 108 that a change in devices connected to the bus 104 has occurred. At action 408, the PnP manager 108 issues a query to learn which devices are connected to the bus 104.

At action 410, the bus driver 112 creates a device object (DO) 602 (assumed to have address, A) representing the device 102. This corresponds to Stage 1 in FIG. 6. Subsequent stages of the assembly of stack 128 are depicted successively to the right of Stage 1.

At action 604, the bus driver 112 creates a list or set 413 of pointers to the DOs representing devices connected to the bus 104. For simplicity, the address, A, of the DO 602 is listed explicitly in the set 413. At action 608, the bus driver 112 sends the set 413 toward the PnP manager 108. Up to this point, the actions in FIG. 6 have corresponded in substance (and in most cases, reference number) to those in FIG. 4.

At action 608, the supplanting filter driver 610 intercepts the list set of pointers 413. At action 612, the supplanting filter driver 610 creates and attaches its own filter DO (FiDO) 614 to DO 602. At action 618, the supplanting filter driver 610 edits the set 413 to replace pointers to the various bus DOs 602 with pointers to its own FiDOs 614, resulting in a changed set 620. At action 622, the supplanting filter driver propagates the changed set 620 to the PnP manager 108.

At Stage 2 of FIG. 6, the PnP manager 108 recognizes or sees the FiDOs 614 corresponding to the pointers in set 620, treating them PDOs; hereafter we refer to FiDOs 614 as FiDO/PDOs 614. At this point a devnode is associated with the stack portion 616, specifically with the FiDO/PDO 614.

Next, the PnP manager 108 participates in the creation of a stack for each new FiDO/PDO identified by the set 620. For simplicity, FIG. 6 assumes that the only new DO in the set 620 is FiDO/PDO 614.

At action 416, the PnP manager 108 passes the FiDO/PDO 614 to the lower filter driver 114. At action 418, the lower filter 114 driver creates and attaches the filter DO (FiDO) 122 to the stack 128, i.e., the FiDO/PDO 614 (which is located in the location immediately the FiDO 122) is manipulated so as to indicate that the FiDO 122 is attached to it. At action 420, the PnP manager 108 passes the FiDO/PDO 614 to the function driver 116. At action 422, the function driver 116 creates and attaches the function DO (FDO) 124 to the stack 128, i.e., manipulates the FiDO 122 to indicate that the FDO 124 is attached to it. At action 424, the PnP manager 108 passes the FiDO/PDO 614 to the upper filter driver 118. At action 426, the upper filter driver 118 creates and attaches the filter DO (FiDO) 126 to the stack 128.

At action 428, the PnP manager 108 notifies potential consumers of the device's services of the arrival of the device. Such potential consumers include dependent device drivers 430 and application 106.

Yet more detail as to stack assembly according to an embodiment of the invention is provided in FIG. 7, which is a sequence diagram according to the unified modeling language (UML) principles. The sequence 700 in FIG. 7 depicts the various interactions between the device 102, the bus 104, the bus driver 112, the PnP manager 108, the device lower filter driver 114, the device function driver 116, the device upper filter driver 118, the supplanting filter driver 610 and the application 106.

At action 518 of FIG. 7, the device 102 connects to the bus 104. The bus 104 then notifies the bus driver 112 of a change in connected devices at action 520. The bus driver 112 notifies the PnP manager 108 of a change in connected devices at action 522. The PnP manager 108 queries the bus driver 112 to obtain a set of connected devices via action 524, e.g., an IRP, to the bus driver 112. If not already known by the bus driver 112, then the bus driver 112 queries the bus 104 to discover the connected devices via the query at action 526. The bus driver 112 creates DOs for newly discovered devices and returns a set 413 of pointers to (addresses of) all DOs representing devices connected to the bus to the PnP manager at action 702.

The supplanting filter driver 610 intercepts the set 413 and enters a loop 703 in which, iteratively, each DO 602 pointed to by the set 413 is examined. At subroutine call 704, the supplanting filter driver 610 determines if the current DO 602 already has an FiDO/PDO associated with it, e.g., by examining a field in the DO 602 that points to the next higher DO in the stack (if one exists). If there is no associated FiDO/PDO, the supplanting filter driver 610 creates and attaches it to the stack, at self action 706.

At self action 708, the supplanting filter driver 610 changes the address of the corresponding pointer in the set 413 so that it points to the FiDO/PDO 614 instead of the DO 602. This will occur for every pointer in the set 413, regardless of whether the current DO 602 is new or not. The result is the formation of the changed pointer set 620. At legend 710, the supplanting filter driver 610 repeats the loop 703 to handle the next DO 602 pointed to by the set 413.

At action 712, the supplanting filter driver 610 propagates the changed pointer set 620 to the PnP manager 108. Upon receiving the set of pointers to the DOs, the PnP manager 108 enters the loop 530 by which it handles any DO pointed to by the set of which the PnP manager 108 was not previously aware (see legend 529) using the same actions as in the loop 530 of FIG. 5. Legend 714 notes that, in the course of carrying out the loop 530, the PnP manager 108 designates the FiDOs 614 as PDOs (hence their description herein as FiDO/PDOs). In other words, providing the changed set of pointers 620 to the PnP manager 418 causes the DOs 602 to be supplanted as PDOs by the FiDOs 614.

Again, a FiDO/PDO can be deleted without disturbing the DO created by the bus, i.e. DO 602. As such, the stack can be disassembled and then later reassembled without the need for an intervening reboot and/or physical disconnection and reconnection of the device.

The invention may be embodied in other forms without departing from its spirit and essential characteristics. The described embodiments are to be considered only non-limiting examples of the invention. The scope of the invention is to be measured by the appended claims. All changes which come within the meaning and equivalency of the claims are to be embraced within their scope.

What is claimed is:

1. A filter driver code arrangement on a computer-readable medium for use in a system having a bus, a host connected to said bus and one or more devices connected to said bus, execution of said code arrangement by one or more processors of said host supplanting first device objects (DOs) with second DOs, the code arrangement comprising:
an intercept code portion to intercept a set of data identifying one or more first DOs, respectively;
a determination code portion to determine addresses of second DOs corresponding to said first DOs identified by said data set, respectively; and
a change code portion to change said data set such that members thereof identify said second DOs rather than said first DOs.

2. The computer-readable code arrangement of claim 1, wherein said first DOs represent devices connected to said bus.

3. The computer-readable code arrangement of claim 2, wherein said first DOs are generated by a bus function driver and said second DOs are filter DOs.

4. The computer-readable code arrangement of claim 1, wherein said data set is a set of pointers pointing to said first DOs, respectively.

5. The computer-readable code arrangement of claim 4,
wherein said first DOs have a field, the purpose of which is to identify one of said second DOs, respectively;
the code arrangement further comprising:
a recognition code portion to recognize as being new any member of said data set for which the corresponding first DO does not yet have a value in said fields which points to a second DO;
a create code portion to create second DOs for the new members of said data set; and
an associate code portion to associate first DOs with the corresponding new second DOs.

6. The computer-readable code arrangement of claim 1, wherein a higher level code portion that originally requested said data set is a plug and play manager.

7. The computer-readable code arrangement of claim 1, wherein said code arrangement conforms to the WINDOWS Driver Model (WDM) architecture.

8. The computer-readable code arrangement of claim 1, wherein said system is a storage area network.

9. A method, for use in a system having a bus, a host connected to said bus and one or more devices connected to said bus, the method supplanting first device objects (DOs) with second DOs, the code arrangement comprising:
intercepting a set of data identifying one or more first DOs;
determining addresses of second DOs corresponding to said first DOs identified by said data set, respectively; and
changing said data set such that members thereof identify said second DOs rather than said first DOs.

10. The method of claim 9, wherein said first DOs represent devices connected to said bus.

11. The method of claim 10, wherein said first DOs are generated by a bus function driver and said second DOs are filter DOs.

12. The method of claim 9, wherein said data set is a set of pointers pointing to said first DOs, respectively.

13. The method of claim 9,
wherein said first DOs have a field, the purpose of which is to identify one of said second DOs, respectively;
the method further comprising:
recognizing as being new any member of said data set for which the corresponding first DO does not yet have a value in said field which points to a second DO;
creating second DOs for the new members of said data set; and
associating first DOs with the corresponding new second DOs.

14. The method of claim 13, wherein a higher level code portion that originally requested said data set is a plug and play manager.

15. The method of claim 9, wherein said code arrangement conforms to the WINDOWS Driver Model (WDM) architecture.

16. The method of claim 11, wherein said system is a storage area network.

17. A host device in a system having a bus, and one or more devices connected to said bus, wherein the host is connected to said bus, the host being operable to supplant a set of data identifying first device objects (DOs) representing said one or more devices connected to said bus, respectively, with a set of data identifying second DOs by loading and executing a code arrangement according to claim 1.

18. An apparatus in a system having a bus and one or more devices connected to said bus, wherein the host is connected to said bus, for supplanting a set of data identifying first device objects (DOs) representing said one or more devices connected to said bus, respectively, with a set of data identifying second DOs, the apparatus comprising:
intercept means for intercepting a set of data identifying one or more first DOs, respectively;
determination means for determining addresses of second DOs corresponding to said first DOs identified by said data set, respectively; and
change means for changing said data set such that members thereof identify said second DOs rather than said first DOs.
